(19) United States
(12) Patent Application Publication
(10) Pub. No.: US 2024/0404407 A1
(43) Pub. Date: Dec. 5, 2024

(54) INFORMATION PROCESSING DEVICE, DISPLAY SYSTEM, AND DISPLAY METHOD

(71) Applicant: Sharp NEC Display Solutions, Ltd., Tokyo (JP)

(72) Inventor: Naoya KIMURA, Tokyo (JP)

(21) Appl. No.: 18/799,425

(22) Filed: Aug. 9, 2024

Related U.S. Application Data
(63) Continuation of application No. PCT/JP2022/005637, filed on Feb. 14, 2022.

(51) Int. Cl. G08G 1/14; G06Q 30/0283; G06T 7/292; G06V 40/10

(52) U.S. Cl. CPC G08G 1/145; G06Q 30/0284; G06T 7/292; G06V 40/10; G06T 2207/30196

(57) ABSTRACT

An information processing device is confuted to acquire a parking position of a vehicle parked in a parking lot, and a first captured image in which a user alighting from the parked vehicle is imaged; a second captured image in which a user passing along a path along which the user is able to move to the parking lot is imaged. The device is confuted to extract a user captured in the second captured image out of users captured in the first captured image, and calculate a time over which the extracted user moves from a position at which the user has been imaged in the second captured image to the parking position at which the vehicle from which the user has alighted has been parked. The device displays a relationship between the time based on the calculation result and the position of the parking lot.

### TECHNICAL FIELD

The present invention relates to an information processing device, a display system, and a display method.

### BACKGROUND ART

There are various methods of parking or availability guidance when a vehicle parks in a single-story or multi-story parking lot of a specific store, but most thereof are to simply display a vacant place at the current time point or to present an approximate crowdedness (an availability state) or a waiting time. That is, in many methods of parking guidance, only guiding to a vacant place at the current time point can be performed. When a parking lot is full or close to full, a driver (customer) using a store waits for exiting of a parked vehicle, but may continue to wander in the parking lot because what vehicle will exit next is not known.

In association with this problem, Patent Document 1 discloses a parking lot management system that presents an exit schedule of a vehicle in each parking section of a parking lot.

In the technique described in Patent Document 1, a cart used by a customer and parking information are correlated, return of the cart to a predetermined position is detected, a predicted time until a parking section becomes available is calculated, and display of a display device for displaying a parking situation in the parking lot is updated on the basis of the predicted time. That is, the technique described in Patent Document 1 is based on the premise that customers use carts. Accordingly, in the technique described in Patent Document 1, an exit schedule cannot be presented when a customer does not use a cart or when a store does not provide carts inherently.

### CITATION LIST

### Patent Document

### [Patent Document 1]

Japanese Patent No. 6875026

### SUMMARY OF INVENTION

### Technical Problem

A problem to be solved is that an exit schedule of a vehicle in each parking section of a parking lot can be presented only when customers use carts.

### Solution to Problem

According to an aspect of the present invention, there is provided an information processing device including: a parking position acquiring unit configured to acquire a parking position of a vehicle parked in a parking lot; a first captured image acquiring unit configured to acquire a first captured image in which a user alighting from the parked vehicle is imaged; a data processing unit configured to store the detected position and the user in a storage unit; a second captured image acquiring unit configured to acquire a second captured image in which a user passing along a path along which the user is able to move to the parking lot is imaged; an extraction unit configured to extract a user captured in the second captured image out of users captured in the first captured image with reference to the storage unit; and a display control unit configured to display availability information on a display unit on the basis of the extraction result.

According to another aspect of the present invention, there is provided a display system including: a detection unit configured to detect a parking position of a vehicle parked in a parking lot; a first imaging unit configured to image a user alighting from the parked vehicle; a storage unit configured to store the detected position and the user; a second imaging unit configured to image a user passing along a path along which the user is able to move to the parking lot; an extraction unit configured to extract a user imaged by the second imaging unit out of users imaged by the first imaging unit with reference to the storage unit; a calculation unit configured to calculate a time over which the extracted user moves from a position at which the user has been imaged by the second imaging unit to the parking position at which the vehicle from which the user has alighted has been parked; and a display unit configured to display a relationship between the time based on the calculation result and the position of the parking lot.

According to another aspect of the present invention, there is provided a display method including: acquiring a parking position of a vehicle parked in a parking lot; acquiring a first captured image in which a user alighting from the parked vehicle is imaged; storing the detected position and the user in a storage unit; acquiring a second captured image in which a user passing along a path along which the user is able to move to the parking lot is imaged; extracting a user captured in the second captured image out of users captured in the first captured image with reference to the storage unit; calculating a time over which the extracted user moves from a position at which the user has been imaged in the second captured image to the parking position at which the vehicle from which the user has alighted has been parked; and displaying a relationship between the time based on the calculation result and the position of the parking lot.

### Advantageous Effects of Invention

According to the present invention, it is possible to present an exit schedule of a vehicle at each position of a parking lot without depending on use of a specific device such as a cart.

### BRIEF DESCRIPTION OF DRAWINGS

FIG. 1 is a diagram schematically illustrating a configuration of a display system according to an embodiment of the present invention.

FIG. 2 is a block diagram schematically illustrating a configuration of the display system according to the embodiment of the present invention.

FIG. 3 is a diagram schematically illustrating a data structure and a data example of a parking state table according to the embodiment of the present invention.

FIG. 4 is a graph illustrating an example of a relationship between a predicted time and a distance from a recognized position to a vehicle according to the embodiment of the present invention.

FIG. 5 is a diagram illustrating a display example of a parking situation according to the embodiment of the present invention.

FIG. 6 is a diagram illustrating another display example of a parking situation according to the embodiment of the present invention.

FIG. 7 is a diagram illustrating another display example of a parking situation according to the embodiment of the present invention.

FIG. 8 is a diagram schematically illustrating an example of installation positions of a second imaging unit and a third imaging unit according to the embodiment of the present invention.

FIG. 9 is a flowchart illustrating an operation flow of a display process that is performed by the display system according to the embodiment of the present invention.

FIG. 10 is a diagram illustrating a configuration of an information processing device 10A according to the embodiment of the present invention.

FIG. 11 is a diagram illustrating a configuration of an information processing device 10B according to another embodiment of the present invention.

FIG. 12 is a diagram illustrating a configuration of a display system 9 according to the embodiment of the present invention.

FIG. 13 is a diagram schematically illustrating an example of a guidance table.

### DESCRIPTION OF EMBODIMENTS

Hereinafter, an embodiment of the present invention will be described.

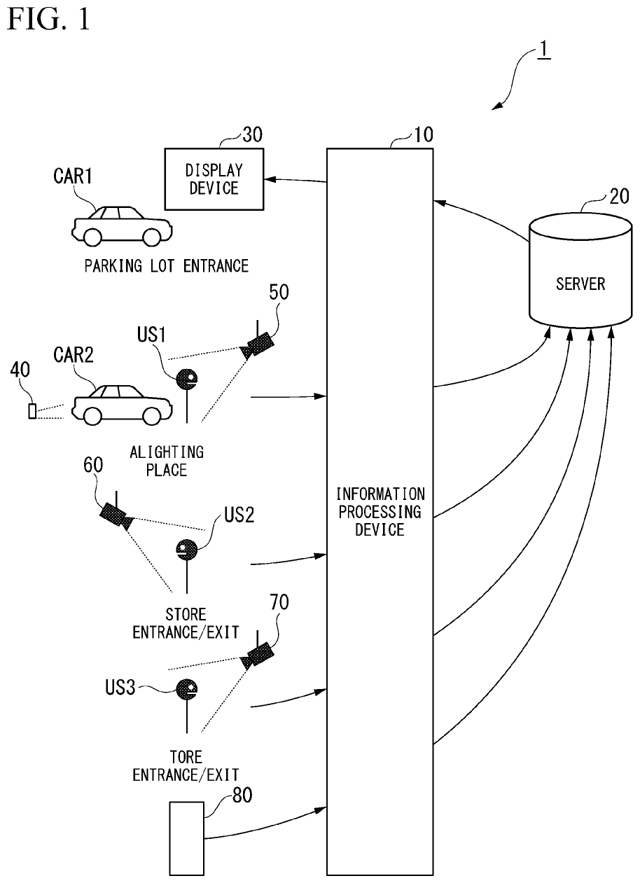

FIG. 1 is a diagram schematically illustrating a configuration of a display system according to an embodiment of the present invention. A display system 1 is a system that displays a parking situation in a parking lot on a display device 30.

In the drawing, the display system 1 includes an information processing device 10, a server 20, a display device 30, a detection unit 40, a first imaging unit 50, a second imaging unit 60, a third imaging unit 70, and a prior settlement machine 80. The detection unit 40, the first imaging unit 50, the second imaging unit 60, the third imaging unit 70, and the prior settlement machine 80 are communicatively connected to the information processing device 10 via a wired or wireless local area network (LAN). The information processing device 10 and the display device 30 are connected to each other via an image cable for transmitting an imaging signal. The information processing device 10 and the server 20 are communicatively connected to each other via a communication network such as the Internet.

The information processing device 10 is a computer that controls display of a parking situation on the display device 30 on the basis of sensor values acquired from the detection unit 40, the first imaging unit 50, the second imaging unit 60, the third imaging unit 70, or the prior settlement machine 80. For example, the information processing device 10 outputs an image signal indicating a parking situation to the display device 30 and causes the display device 30 to display the parking situation.

The server 20 is a server device that comprehensively controls the display system 1.

The display device 30 is a display that is installed at a position visible to a driver of a vehicle CAR1 using the parking lot such as a parking lot entrance and displays the parking situation of the parking lot on a display screen thereof. In the drawing, only one display device 30 is illustrated, but the display device 30 may be installed at a plurality of positions in the parking lot in addition to the parking lot entrance.

The detection unit 40 detects a parking position of a vehicle parked in the parking lot. For example, the detection unit 40 detects a parking position (for example, a section corresponding to one vehicle or an area including a predetermined number of sections) in the parking lot in which a vehicle CAR2 parks. The detection unit 40 may be an entrance sensor installed in each section or a camera for imaging each section as long as it can detect a parking position of a vehicle parked in the parking lot. The detection unit 40 transmits a sensor value indicating the detected parking position to the information processing device 10.

The first imaging unit 50 is a camera that images a user US1 alighting from the parked vehicle CAR2 and a vehicle number of the vehicle CAR2. The first imaging unit 50 generates a first captured image in which the user US1 alighting from the parked vehicle CAR2 and the vehicle number of the vehicle CAR2 are imaged and transmits the generated first captured image to the information processing device 10.

In the drawing, the detection unit 40 and the first imaging unit 50 are different devices, but functions of both the detection unit 40 and the first imaging unit 50 may be realized by one camera. In the drawing, the first imaging unit 50 images the user US1 alighting from the vehicle CAR2 and the vehicle number of the vehicle CAR2, but the present invention is not limited thereto and the user US1 alighting from the vehicle CAR2 and the vehicle number of the vehicle CAR2 may be imaged by different cameras.

The second imaging unit 60 is a camera that images the user US2 moving along a path along which a user is able to move to the parking lot. The second imaging unit 60 images the path along which a user is able to move to only the parking lot. The path along which a user is able to move to the parking lot is positions through which a user can be predicted to move to the parking lot. For example, in case of a parking lot of a store, the path along which a user is able to move to the parking lot is a store entrance/exit or the like. The second imaging unit 60 images a user US2 exiting the store when it is installed at the store entrance/exit. When the parking lot is located in the roof floor or the underground of the store, the second imaging unit 60 may be installed in an escalator, a passage, or the like connected to the roof floor or the underground. The second imaging unit 60 generates a second captured image in which the user US2 passing along the path along which a user is able to move to the parking lot is imaged and transmits the generated second captured image to the information processing device 10.

The third imaging unit 70 is a camera for imaging a user US3 moving in a direction in which the user moves away from the parking lot in the path along which a user is able to move to the parking lot. The third imaging unit 70 generates a third captured image in which the user US3 moving in a direction in which the user moves away from the parking lot is imaged and transmits the generated third captured image to the information processing device 10.

The prior settlement machine 80 is a device that settles a parking fee for the parking lot in advance. The prior settlement machine 80 transmits settlement information including a vehicle number of a vehicle of which the parking fee has been prior settled to the information processing device 10.

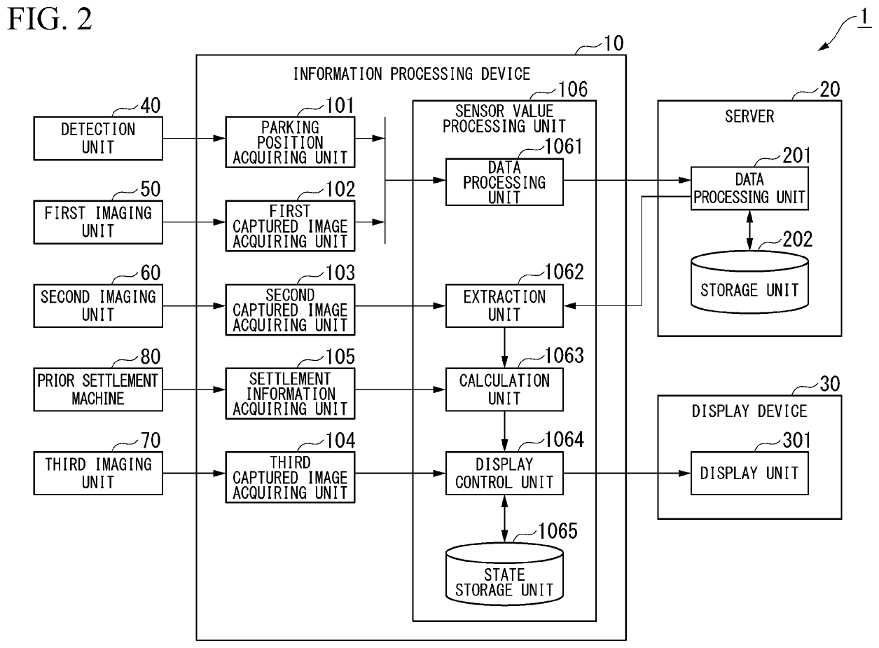

FIG. 2 is a block diagram schematically illustrating a configuration of the display system according to the embodiment of the present invention. In the drawing, the information processing device 10 includes a parking position acquiring unit 101, a first captured image acquiring unit 102, a second captured image acquiring unit 103, a third captured image acquiring unit 104, a settlement information acquiring unit 105, and a sensor value processing unit 106.

The parking position acquiring unit 101 acquires a parking position of a vehicle parked in the parking lot. For example, the parking position acquiring unit 101 acquires the parking position in the parking lot in which a vehicle CAR2 parks from the detection unit 40.

The first captured image acquiring unit 102 receives and acquires a first captured image in which a user US1 alighting from the parked vehicle CAR2 and a vehicle number of the vehicle CAR2 are imaged from the first imaging unit 50.

The second captured image acquiring unit 103 receives and acquires a second captured image in which a user US2 passing along the path along which a user is able to move to the parking lot is imaged from the second imaging unit 60.

The third captured image acquiring unit 104 receives and acquires a third captured image in which a user US3 moving in a direction in which the user moves away from the parking lot in the path along which a user is able to move to the parking lot is imaged from the third imaging unit 70.

The settlement information acquiring unit 105 receives and acquires settlement information indicating that prior settlement of a parking fee has been performed by the prior settlement machine 80.

The sensor value processing unit 106 is a central processing unit (CPU) that comprehensively controls the information processing device 10. The sensor value processing unit 106 includes a data processing unit 1061, an extraction unit 1062, a calculation unit 1063, a display control unit 1064, and a state storage unit 1065.

The data processing unit 1061 recognizes a user from the first captured image and generates first recognition information which is the recognition result. The first recognition information is data for identifying the user and may be, for example, a result of face recognition of the user, data indicating a physique, a dress, or the like of the user, or the first captured image itself. The data processing unit 1061 recognizes a vehicle number from the first captured image. Then, the data processing unit 1061 transmits the detected parking position, the generated first recognition information, and the recognized vehicle number in correlation to the server 20 and stores the correlation in a storage unit 202 of the server 20.

The extraction unit 1062 recognizes a user from the second captured image and generates second recognition information which is the recognition result thereof. The extraction unit 1062 transmits the generated second recognition information to the server 20 and extracts a user imaged by the second imaging unit 60 out of users imaged by the first imaging unit 50 with reference to the storage unit 202.

The calculation unit 1063 calculates a time over which the extracted user moves from a position at which the user has been imaged by the second imaging unit 60 to a parking position in the parking lot at which a vehicle from which the user has alighted parks. When the settlement information acquiring unit 105 has acquired settlement information, the calculation unit 1063 calculates a time over which a user moves from the prior settlement machine 80 to a position in the parking lot at which a vehicle for which there has been prior settlement parks.

The display control unit 1064 displays availability information on a display unit 301 of the display device 30 on the basis of the extraction result from the extraction unit 1062. The availability information is information on availability of a parking position. The availability information may be, for example, information indicating at least one of a time until a parking position will be available because a vehicle parking at the parking position has exited, an availability indicating that a vehicle is not parked at the parking position, an unavailability indicating that a vehicle is parked at the parking position, and a schedule in which an unavailable parking position becomes available. The time until a parking position is available may be a predetermined time or may be a time which is estimated on the basis of the extraction result from the extraction unit 1062.

The display control unit 1064 displays a parking situation of the parking lot on the display unit 301 of the display device 30 with reference to a parking state table stored in the state storage unit 1065. For example, the display control unit 1064 displays a relationship between a time based on the calculation result and the parking position of the parking lot on the display unit 301 of the display device 30. The time based on the calculation result may be the calculation result itself from the calculation unit 1063 or may be a time corrected according to a walking speed of a user based on the second captured image. The display control unit 1064 displays the time based on the calculation result for each section included in the parking lot together. Alternatively, the display control unit 1064 may display the time based on the calculation result on the display unit 301 installed at a position corresponding to each section included in the parking lot. When a user imaged by the second imaging unit 60 is imaged by the third imaging unit 70, the display control unit 1064 deletes (does not display any more) the time displayed on the display unit 301. When a user imaged by the second imaging unit 60 is not extracted by the extraction unit 1062 and a corresponding vehicle exits, the display control unit 1064 displays information indicating that a parking position in the parking lot at which the vehicle has been parked is available. When an availability ratio in the parking lot is less than a predetermined value, the display control unit 1064 may display a relationship between the time based on the calculation result and a position in the parking lot.

The state storage unit 1065 stores a parking state table indicating a parking state at each parking position of the parking lot.

The server 20 includes a data processing unit 201 and a storage unit 202.

The data processing unit 201 processes data received from the information processing device 10. For example, when data including a parking position, first recognition information, and a vehicle number is received, the data processing unit 201 stores the received parking position, the received first recognition information, and the received vehicle number in the storage unit 202 in correlation. When second recognition information is received, the data processing unit 201 extracts first recognition information matching the second recognition information from the storage unit 202 and returns the parking position corresponding to the extracted first recognition information to the information processing device 10.

The storage unit 202 stores the detected parking position, the user (first recognition information), and the vehicle number in correlation.

The display device 30 includes a display unit 301.

The display unit 301 displays a parking situation of the parking lot based on an image signal input from the information processing device 10. For example, the display unit 301 displays a relationship between the time based on the calculation result and the parking position of the parking lot. Specifically, the display unit 301 displays the time based on the calculation result for each section included in the parking lot together. Alternatively, the display unit 301 may be installed at a position corresponding to each section included in the parking lot. When a user imaged by the second imaging unit 60 is imaged by the third imaging unit 70, the display unit 301 deletes (does not display any more) the displayed time. When a user imaged by the second imaging unit 60 is not extracted by the extraction unit 1062 and a corresponding vehicle exits, the display unit 301 displays information indicating that a parking position in the parking lot at which the vehicle has been parked is available. When an availability ratio in the parking lot is less than a predetermined value, the display unit 301 may display a relationship between the time based on the calculation result and a position in the parking lot.

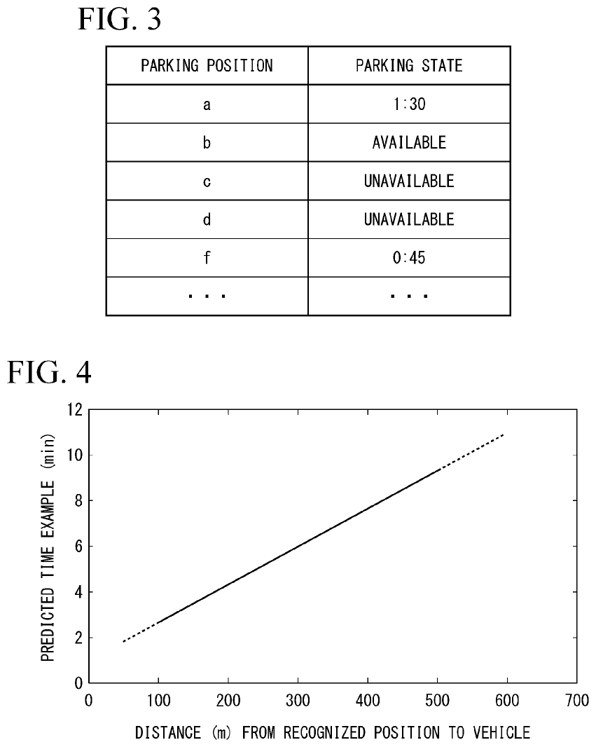

FIG. 3 is a diagram schematically illustrating a data structure and a data example of the parking state table according to the embodiment of the present invention.

As illustrated in the drawing, the parking state table includes entries of a parking position and a parking state. The parking state indicates a parking state at the corresponding parking position. The parking state includes “unavailable” indicating that a vehicle has been parked, “available” indicating that no vehicle has been parked, and an “availability prediction timer” indicating an exit schedule indicating that a vehicle exits in a short time. The short time mentioned herein is a time (for example, 10 minutes) in which a parking-waiting vehicle wandering in the parking lot can wait. The availability prediction timer is a predicted time until a vehicle exits, and the unit thereof in this example is “minutes.”

In the illustrated example, the parking state at parking position “a” is an availability prediction timer “1:30 (1 minutes and 30 seconds), the parking state at parking position “b” is “available,” the parking state at parking position “c” is “unavailable,” the parking state at parking position “d” is “unavailable,” and the parking state at parking position “a” is an availability prediction timer “0:45 (45 seconds).” That is, in this example, a vehicle at parking position “f” is scheduled to exit after 1 minute has elapses, and a vehicle at parking position “b” is scheduled to exit after 45 seconds elapses.

Operations of the display system 1 will be described below.

### (Basic Operations)

First, when a vehicle parks in a parking lot, the detection unit 40 Detects the Parking position. The data processing unit 1061 of the information processing device 10 changes the parking state of the detected parking position in the parking state table stored in the state storage unit 1065 to “unavailable.” The display control unit 1064 changes the parking state of the detected parking position to unavailable with reference to the parking state table stored in the state storage unit 1065. Then, the first imaging unit 50 images a user alighting from the vehicle parking at the detected parking position and a vehicle number thereof and generates a first captured image. The data processing unit 1061 of the information processing device 10 generates first recognition information of the user from the first captured image through image recognition and recognizes the vehicle number from the first captured image. Then, the data processing unit 1061 stores the detected parking position, the generated first recognition information, and the recognized vehicle number in the storage unit 202 of the server 20 in correlation.

Thereafter, when a user ends shopping in a store or the like and passes along a path along which a user is able to move to a parking lot, the second imaging unit 60 images the user predicted to move to the parking lot and generates a second captured image. The extraction unit 1062 of the information processing device 10 generates second recognition information of the user from the second captured image and extracts the first recognition information matching the generated second recognition information with reference to the storage unit 202. At this time, the extraction unit 1062 may extract the user through face recognition or extract the user, for example, on the basis of matching of dresses. Thereafter, the calculation unit 1063 of the information processing device 10 calculates a predicted time over which the user moves from the position at which the second captured image is captured to the parking position correlated with the extracted first recognition information.

FIG. 4 is a graph illustrating an example of a relationship between a predicted time and a distance from a recognized position to a vehicle according to the embodiment of the present invention.

In the graph illustrated in the drawing, the horizontal axis represents a distance (the unit of which is “m (meter)”) from the position at which a user has been recognized by the second imaging unit 60 to a parking position of a vehicle, and the vertical axis represents the predicted time (the unit of which is “minutes”). In the illustrated example, the predicted time increases in proportion to the distance. The calculation unit 1063 stores data of the graph illustrated in the drawing. The data stored in the calculation unit 1063 may be an equation or a table in which data itself is stored.

The calculation unit 1063 calculates the predicted time on the basis of the stored data. Here, the calculation unit 1063 stores position information of the second imaging unit 60 and position information of parking positions in advance. The calculation unit 1063 may detect a walking speed of a user on the basis of the second captured image and correct the predicted time on the basis of the detected walking speed. The calculation unit 1063 changes the parking state of the corresponding parking position in the parking state table stored in the state storage unit 1065 to the calculated predicted time. Thereafter, the display control unit 1064 displays a relationship between the calculated predicted time and the parking position on the display unit 301 of the display device 30 with reference to the parking state table stored in the state storage unit 1065.

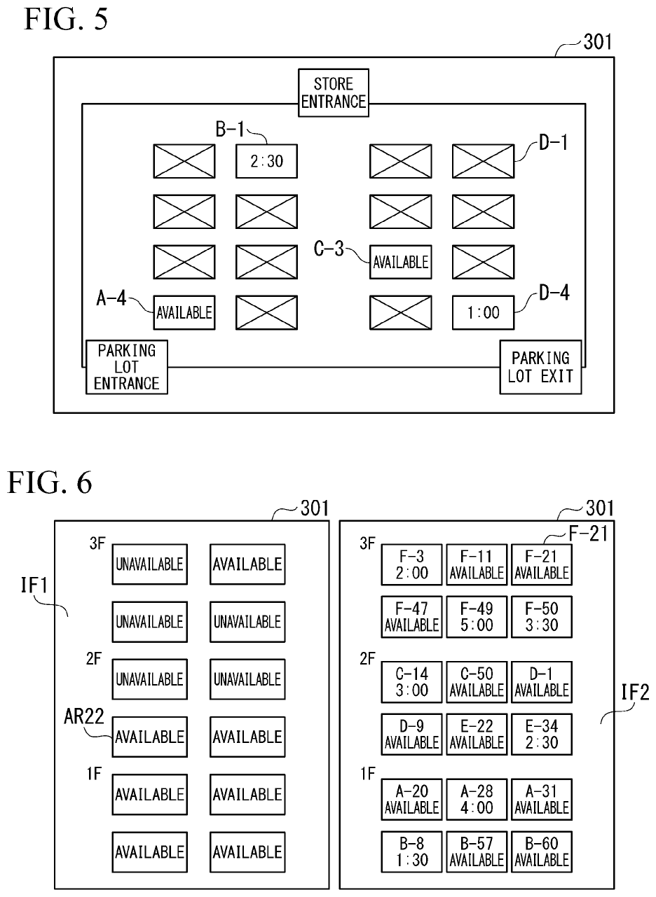

FIG. 5 is a diagram illustrating a display example of a parking situation according to the embodiment of the present invention.

The display control unit 1064 displays a parking situation of the parking lot on the display unit 301 with reference to the parking state table stored in the state storage unit 1065. In the example illustrated in the drawing, the display control unit 1064 displays an availability prediction timer for each section included in the parking lot. In the drawing, the display control unit 1064 displays parking states of the sections on a layout of the parking lot using “available” indicating that a section is available, “x” indicating that a section is unavailable, and an availability prediction timer indicating that a vehicle is scheduled to exit at a displayed time. The availability prediction timer is a predicted remaining time until exit obtained by counting down the calculated predicted time with the elapse of time.

In the illustrated example, section A-4 and section C-3 are available, section B-1 and section D-4 are availability prediction timers, and other sections including section D-1 are unavailable. A vehicle is scheduled to exit from section B-1 after 2 minutes and 30 seconds elapse, and a vehicle is scheduled to exit from section D-4 after 1 minute elapses.

In this way, by displaying an availability prediction timer until a vehicle exits in correlation with each section, it is possible to notify a driver of a vehicle which will park what position will be available specifically in certain minutes.

Thereafter, when a vehicle exits, the detection unit 40 detects a parking position at which the exiting vehicle has been parked. The data processing unit 1061 of the information processing device 10 changes the parking state of the parking position from which an exit has been detected in the parking state table stored in the state storage unit 1065 to “available.” The display control unit 1064 changes display of the parking state of the parking position from which an exit has been detected to available with reference to the parking state table stored in the state storage unit 1065.

A user imaged by the first imaging unit 50 and a user imaged by the second imaging unit 60 may not match each other because the user wears a sunglass at the time of alighting but takes off the sunglass at the time of exiting the store or the like. Accordingly, when a user imaged by the first imaging unit 50 is not imaged by the second imaging unit 60, but the detection unit 40 detects that the vehicle exits, the display control unit 1064 changes the parking state of the parking position from which an exit has been detected to available.

FIG. 6 is a diagram illustrating another display example of a parking situation according to the embodiment of the present invention.

In the drawing, a display example when a parking lot is large and thus it is difficult to display a parking situation of the whole parking lot together is illustrated. In the example illustrated in the drawing, the display control unit 1064 displays an availability prediction timer only when an availability ratio in the whole parking lot is less than a predetermined value. The display control unit 1064 selectively displays a parking situation IF1 of the whole parking lot and a parking situation IF2 in which only a section which is available or from which a vehicle is scheduled to exit is displayed on the basis of the availability ratio.

Specifically, when the availability ratio is equal to or greater than the predetermined value, the display control unit 1064 partitions the parking lot into a plurality of areas and displays a parking situation IF1 of each area on the display unit 301. In the parking situation IF1 described in this example, each floor of a parking lot including three floors is partitioned into four areas, and whether each area is unavailable or available is displayed. In this example, the display control unit 1064 displays an unavailable area in the parking situation IF1 as “unavailable” and displays an available area as “available.” For example, “available” is displayed in an area AR22 of the second floor including availability. In this example, the display control unit 1064 displays a parking situation of each area using text, but the present invention is not limited thereto and the parking situation may be displayed in color or availability ratio.

On the other hand, when the availability ratio is less than the predetermined value, the display control unit 1064 displays a parking situation IF2 indicating an available section and an exit-scheduled section on the display unit 301. In the parking situation IF2 described in this example, an individual number and “available” are displayed for an available section in each floor of a parking lot including three floors and an individual number and an availability prediction timer are displayed for an exit-scheduled section. For example, in an available section F-21, an individual umber “F-21” and “available” are displayed. The display control unit 1064 does not display an unavailable section in the parking situation IF2. In the illustrated example, sections A-20, B-31, B-57, and B-60 in the first floor, sections C-50, D-1, D-9, and E-22 in the second floor, and sections F-11, F-21, and F-47 in the third floor are available. A vehicle is scheduled to exit the section A-28 in the first floor after 4 minutes elapses, a vehicle is scheduled to exit the section B-8 after 1 minute and 30 seconds elapses, a vehicle is scheduled to exit the section C-14 in the first floor after 3 minutes elapses, a vehicle is scheduled to exit the section E-34 after 2 minutes and 30 seconds elapses, a vehicle is scheduled to exit the section F-3 in the third floor after 2 minutes elapses, a vehicle is scheduled to exit the section F-49 after 5 minutes elapses, and a vehicle is scheduled to exit the section F-50 after 3 minutes and 30 seconds elapses.

In this way, by displaying only an available section or an exit-scheduled section only when the availability ratio is less than a predetermined value, it is possible to guide a driver to an available section or an exit-scheduled section even when a parking lot is large and thus it is difficult to display a parking situation of the whole parking lot together.

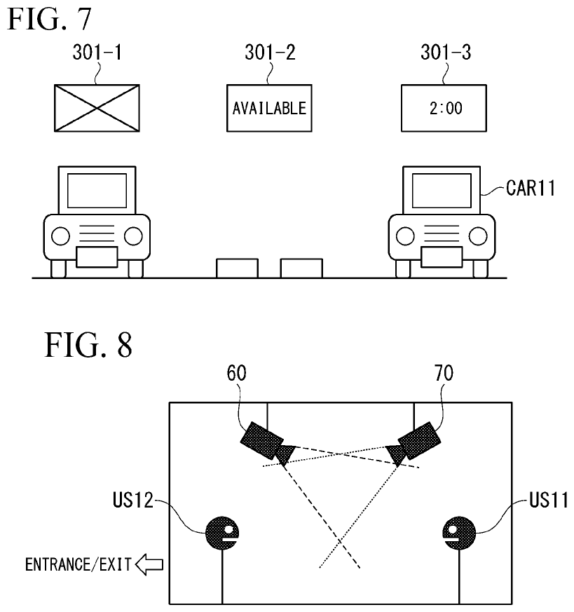

FIG. 7 is a diagram illustrating another display example of the parking situation according to the embodiment of the present invention.

In the example illustrated in the drawing, the display unit 301 is installed at a position corresponding to each section. That is, a plurality of display devices 30 are provided according to the number of sections in the parking lot. The display unit 301 is installed at a position (for example, above each section) which is visible to a driver of a parking waiting vehicle which will park now even when a vehicle has been parked in the section. In the illustrated example, three display units 301 such as display units 301-1, 301-2, and 301-3 are illustrated. The display unit 301-1 displays “x” indicating that the corresponding section is unavailable. The display unit 301-2 displays “available” indicating that the corresponding section is available. The display unit 301-3 displays an availability prediction timer “2:00” indicating that a vehicle CAR11 parked in the corresponding section is scheduled to exit after 2 minutes elapses.

In this way, by displaying an availability prediction timer on the display unit 301 installed at a position corresponding to each section, it is possible to easily inform a driver in what section a vehicle is scheduled to exit.

(Operation when User Having Move Back to Parking Lot Leaves Parking Lot Again)

A case in which an availability prediction timer is displayed but a vehicle has not actually exited such as a case in which a user temporarily moves back to a vehicle and then moves to a store again, for example, due to a lost article is also assumed. Accordingly, when a user having moved once to the parking lot leaves the parking lot again on the basis of recognition results of the second captured image and the third captured image, the information processing device 10 resets a displayed availability prediction timer and returns display for the corresponding parking position to unavailable.

FIG. 8 is a diagram schematically illustrating an example of installation positions of the second imaging unit and the third imaging unit according to the embodiment of the present invention.

In the drawing, it is assumed that the second imaging unit 60 and the third imaging unit 70 are installed at an entrance/exit of a store in which a parking lot is provided. As illustrated in the drawing, the second imaging unit 60 is installed at the entrance/exit of the store such that it images only a user US11 moving out from the store. That is, the second imaging unit 60 images a user US11 moving out from the store from the front. On the other hand, the third imaging unit 70 is installed at the entrance/exit of the store such that it images only a user US12 moving into the store. That is, the third imaging unit 70 images a user US12 moving into the store from the front. By installing the second imaging unit 60 and the third imaging unit 70 in this way, it is possible to recognize a user moving from the store to the parking lot using the second captured image and to recognize a user moving from the parking lot and moving into the store using the third captured image. Accordingly, it is possible to distinguish a user moving to the parking lot and a user moving away from the parking lot in a path along which a user is able to move to the parking lot.

Accordingly, when a user recognized from the second captured image is recognized from the third captured image after an availability prediction timer has been displayed, the display control unit 1064 determines that a vehicle does not exit, resets display of the availability prediction timer, and returns display of the corresponding parking position and a parking state in the parking state table to unavailable. As a result, it is possible to reduce erroneous display of an availability prediction timer.

(Operation when Parking Fee has been Prior Settled)

When a parking fee has been prior settled using a prior settlement machine 80, it is assumed that a vehicle exits at an earlier timing than a predicted time based on recognition of a user by the second imaging unit 60. Accordingly, when a parking fee has been prior settled, the information processing device 10 gives priority to prior settlement more than recognition by the second imaging unit 60 and displays an availability prediction timer for a predicted time over which the user moves from the position of the prior settlement machine 80 having performed the prior settlement to a parking position of a vehicle on the display unit 301. Specifically, when settlement information is received from the prior settlement machine 80, the calculation unit 1063 reads a parking position corresponding to a vehicle number included in the received settlement information from the storage unit 202. Then, the calculation unit 1063 calculates a predicted time based on a distance from the position of the prior settlement machine 80 which is source of the received settlement information to the read parking position and changes the parking state in the parking state table to the predicted time. The calculation unit 1063 stores the position information of the prior settlement machine 80 in advance. The display control unit 1064 displays an availability prediction timer based on the calculated prediction time in correlation with the read parking position on the display unit 301 with reference to the parking state table. In this way, by displaying an availability prediction timer even when a parking fee has been prior settled, it is possible to improve accuracy of the availability prediction timer.

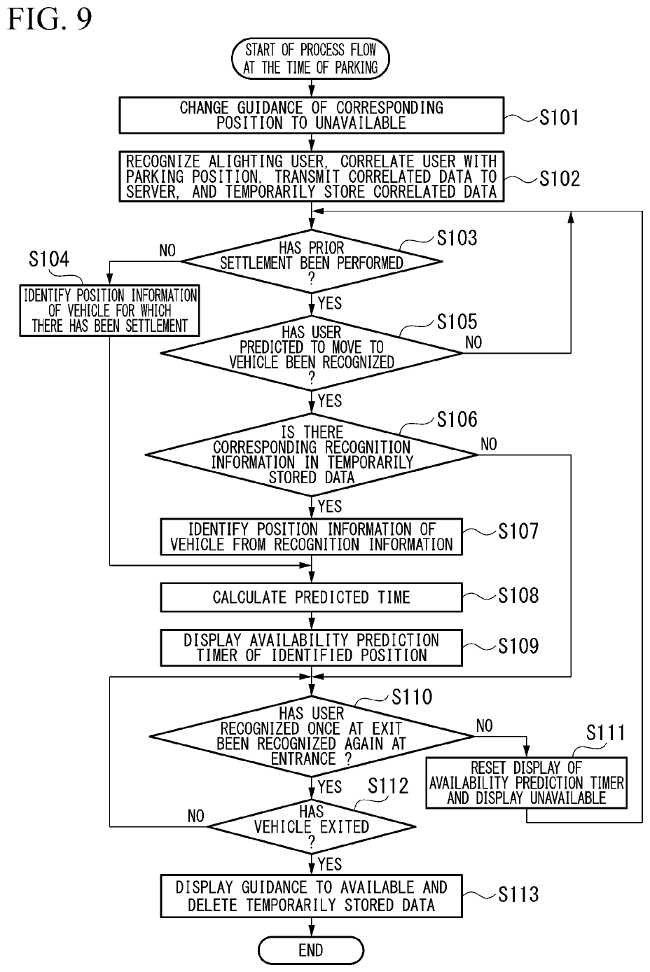

FIG. 9 is a flowchart illustrating a process flow of a display process that is performed by the display system according to the embodiment of the present invention.

When a vehicle is parked in a parking lot, the information processing device 10 performs the process flow illustrated in the drawing. First, the detection unit 40 detects a parking position of the vehicle parked in the parking lot. Then, the display control unit 1064 of the information processing device 10 changes display of the parking state corresponding to the detected parking position to unavailable (Step S101). Subsequently, the first imaging unit 50 generates a first captured image in which a user alighting from the parked vehicle and a vehicle number thereof are imaged. The data processing unit 1061 of the information processing device 10 recognizes the user and the vehicle number from the first captured image, transmits the recognized first recognition information and the recognized vehicle number to the server 20 in correlation with the detected parking position, and temporarily stores the transmitted data (Step S102). The data processing unit 201 of the server 20 stores the received data in the storage unit 202.

Subsequently, the sensor value processing unit 106 of the information processing device 10 determines whether prior settlement has been performed (Step S103). The sensor value processing unit 106 determines that prior settlement has been performed when settlement information is received from the prior settlement machine 80 and determines that prior settlement has not been performed when settlement information is not received.

When prior settlement has been performed (Step S103: NO), the calculation unit 1063 of the information processing device 10 identifies the parking position of the vehicle for which there has been prior settlement (Step S104). Specifically, the calculation unit 1063 reads the parking position corresponding to the vehicle number included in the received settlement information from the storage unit 202 of the server 20. Thereafter, the process flow proceeds to Step S108.

On the other hand, when prior settlement has not ben performed (Step S103: YES), the extraction unit 1062 of the information processing device 10 determines whether a user predicted to move to the vehicle has been recognized on the basis of a second captured image captured by the second imaging unit 60 (Step S105). When a user has not been recognized (Step S105: NO), the process flow returns to Step S103.

On the other hand, when a user has been recognized from the second captured image (Step S105: YES), the extraction unit 1062 determines whether the user recognized from the second captured image is included in the users indicated by the temporarily stored first recognition information (Step S106). When there is no matching first recognition information (Step S106: NO), the process flow proceeds to Step S110.

On the other hand, when there is matching first recognition information (Step S106: YES), the calculation unit 1063 of the information processing device 10 reads a parking position corresponding to the matching first recognition information from the storage unit 202 of the server 20 and identifies the parking position of the vehicle (Step S107).

Thereafter, the calculation unit 1063 calculates a predicted time on the basis of a distance from the position of the second imaging unit 60 by which a user has been recognized or the prior settlement machine 80 having performed prior settlement to the identified parking position (Step S108).

Then, the display control unit 1064 displays an availability prediction timer based on the calculated predicted time on the display unit 301 in correlation with the identified parking position (Step S109).

Thereafter, the display control unit 1064 determines whether a user recognized once at an exit of a store has been recognized again at an entrance (Step S110). Specifically, when a user recognized from the second captured image has been recognized from the third captured image, the display control unit 1064 determines that a user recognized once at an exit of a store has been recognized again at an entrance. When a user recognized once at an exit has been recognized again at an entrance (Step S110: NO), the display control unit 1064 resets the displayed availability prediction timer and returns display of the corresponding parking position to unavailable (Step S111). Thereafter, the process flow returns to Step S103.

On the other hand, when a user recognized once at an exit has not been recognized again at an entrance (Step S110: YES), the display control unit 1064 determines whether the corresponding vehicle has exited the parking lot on the basis of a detection result from the detection unit 40 (Step S112). When the vehicle has not exited (Step S112: NO), the process flow returns to Step S110.

On the other hand, when the vehicle has exited the parking lot (Step S112: YES), the display control unit 1064 changes display of the parking state corresponding to the parking lot which the vehicle has exited to be available and deletes the temporarily stored data of the parking position from the storage unit 202 of the server 20 (Step S113). Thereafter, the process flow ends.

As described above, the display system 1 according to this embodiment includes the detection unit 40 configured to detect a parking position of a vehicle parked in a parking lot, the first imaging unit 50 configured to image a user alighting from the parked vehicle, the storage unit 202 configured to store the detected position and the user, the second imaging unit 60 configured to image a user passing along a path along which the user is able to move to the parking lot, the extraction unit 1062 configured to extract a user imaged by the second imaging unit 60 out of users imaged by the first imaging unit 50 with reference to the storage unit 202, the calculation unit 1063 configured to calculate a time over which the extracted user moves from a position at which the user has been imaged by the second imaging unit 60 to the parking position at which the vehicle from which the user has alighted has been parked, and the display unit 301 configured to display a relationship between the time based on the calculation result and the position of the parking lot.

With this configuration, when a user parking a vehicle in the parking lot moves back to the parking lot through a path along which a user is able to move to the parking lot, it is possible to predict that the vehicle will exit and to display a predicted time until exiting in correlation with the parking position of the vehicle. Accordingly, it is possible to inform a driver of a parking waiting vehicle which will park what position will be available in what specific timing (for example, after several minutes). As a result, it is possible to contribute to resolution of wandering for waiting for parking. For example, even in a situation in which there is demand for parking in the vicinity of an entrance of a building but only a place far from the building entrance is available, a driver can see after what time a place in the vicinity of the entrance is available.

The second imaging unit 60 images a path along which a user is able to move to only the parking lot. Accordingly, since only a user moving to the parking lot can be imaged, it is possible to prevent recognition of a user moving to other than the parking lot and to reduce erroneous display of a time.

The display unit 301 displays availability information along with a time based on the calculation result for each section included in the parking lot. Accordingly, it is possible to easily inform a driver what section in the parking lot a vehicle is scheduled to exit at what timing.

The display unit 301 is installed at a position corresponding to each section included in the parking lot. Accordingly, it is possible to more easily inform a driver what section a vehicle is scheduled to exit. For example, it is possible to inform a driver of a parking waiting vehicle wandering in the parking lot that a nearby (for example, in front of the eyes) vehicle is scheduled to exit.

The second imaging unit 60 images a user moving to the parking lot, the information processing device further includes the third imaging unit 70 configured to image a user moving in a direction in which the user moves away from the parking lot in the path along which a user is able to move to the parking, and the display unit 301 deletes the displayed time (does not display the displayed time any more) when a user imaged by the second imaging unit 60 is imaged by the third imaging unit 70. Accordingly, when the corresponding vehicle has not exited such as when the user temporarily moves back to the vehicle and then moves to the store again, for example, due to a lost article, it is possible to reduce erroneous display of the time.

The display unit 301 displays information indicating that a position of the parking lot at which a vehicle has been parked is available when the user imaged by the second imaging unit 60 has not been extracted by the extraction unit 1062 and when the vehicle has exited the parking lot. For example, it may be assumed that there is no matching recognition information in the temporarily stored data because the user wears a sunglass at the time of alighting but takes off the sunglass at the time of exiting the store or the like. Accordingly, when there is no matching first recognition information in the second recognition information, the information processing device 10 does not display an availability prediction timer and performs the process of detecting exiting of a vehicle. As a result, when the vehicle exits, it is possible to inform a driver of a parking waiting vehicle that the position at which the vehicle has been parked is available.

The display system further includes the settlement information acquiring unit 105 configured to acquire settlement information indicating that prior settlement of a parking fee has been performed using the prior settlement machine 80, and the calculation unit 1063 calculates a time over which a user moves from the prior settlement machine 80 to the position of the parking lot at which the vehicle for which there has been prior settlement has been parked when the settlement information is acquired. Accordingly, it is possible to display an exit-scheduled time even when a parking fee has been prior settled. As a result, it is possible to improve accuracy of time display.

The display unit 301 displays a relationship between the time based on the calculation result and the position of the parking lot when an availability ratio in the parking lot is less than a predetermined value. Accordingly, for example, even when the parking lot is large and thus it is difficult to display a parking situation of the whole parking lot together, it is possible to easily inform a driver of a parking waiting vehicle of an exit-scheduled position.

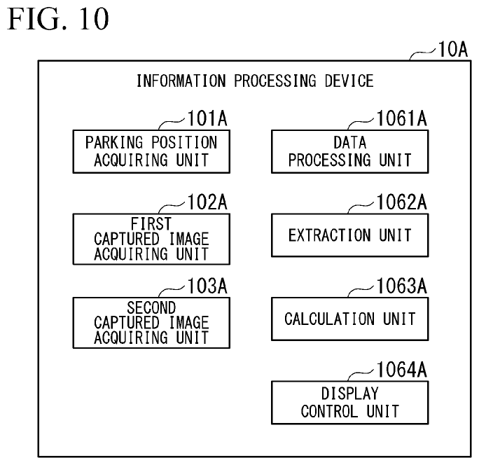

FIG. 10 is a diagram illustrating a configuration of an information processing device 10A according to another embodiment of the present invention.

The information processing device 10A includes, a parking position acquiring unit 101A, a first captured image acquiring unit 102A, a data processing unit 1061A, a second captured image acquiring unit 103A, an extraction unit 1062A, a calculation unit 1063A, and a display control unit 1064A.

The parking position acquiring unit 101A acquires a position in a parking lot at which a vehicle has been parked.

The first captured image acquiring unit 102A acquires a first captured image in which a user alighting from the parked vehicle is imaged.

The data processing unit 1061A stores the detected position and the user in a storage unit.

The storage unit may be a storage device provided in the information processing device 10A or a storage unit externally connected to the information processing device 10A.

The second captured image acquiring unit 103A acquires a second captured image in which a user passing along a path along which a user is able to move to the parking lot is imaged.

The extraction unit 1062A extracts a user imaged in the second captured image out of users imaged in the first captured image with reference to the storage unit.

The calculation unit 1063A calculates a time over which the extracted user moves from the position at which the user is imaged in the second captured image to the position of the parking lot at which the vehicle from which the user has alighted parks.

The display control unit 1064A externally outputs availability information on the basis of the extraction result from the extraction unit 1062A. When the display control unit 1064A externally outputs the availability information, it is possible to display the availability information on an external display unit. The external display unit may be, for example, one of a display device connected to the information processing device 10A via an image cable, a car navigation device of a vehicle in which a user intending to park in the parking lot is, and a smartphone carried by the user. The display device is installed in the vicinity of the parking lot and may be installed at an entrance gate of the parking lot or in the vicinity thereof. The information processing device 10A and the car navigation device may be communicatively connected to each other via the Internet in a wireless manner or may be communicatively connected to each other through short-range wireless communication. The information processing device 10A and the smartphone may be communicatively connected to each other via the Internet in a wireless manner or may be communicatively connected to each other through short-range wireless communication.

The information processing device 10A displays a relationship between the time and the parking lot on the display unit on the basis of the calculation result from the calculation unit 1063A. For example, a time over which a user moves from the position at which the user is imaged in the second captured image to the position of the parking lot at which the vehicle from which the user has alighted parks and which has been calculated by the calculation unit 1063A may be output as availability information to a display unit. The display unit may be a display unit of a display device externally connected to the information processing device 10A.

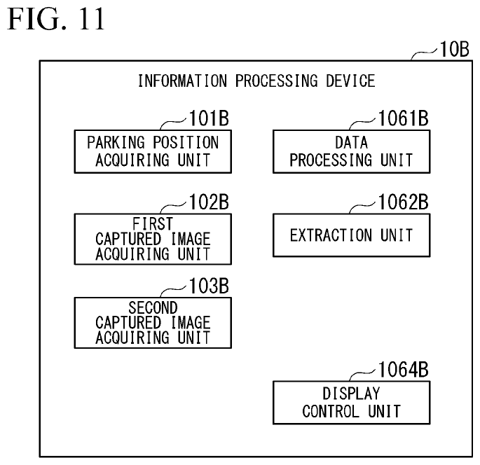

FIG. 11 is a diagram illustrating a configuration of an information processing device 10B according to another embodiment of the present invention.

The information processing device 10B includes, a parking position acquiring unit 101n, a first captured image acquiring unit 102B, a data processing unit 1061i, a second captured image acquiring unit 103B, an extraction unit 1062B, an availability information generating unit 1063B, and a display control unit 1064B.

The parking position acquiring unit 101B acquires a position in a parking lot at which a vehicle has been parked.

The first captured image acquiring unit 102B acquires a first captured image in which a user alighting from the parked vehicle is imaged.

The data processing unit 1061B stores the detected position and the user in a storage unit. The storage unit may be a storage device provided in the information processing device 10B or a storage unit externally connected to the information processing device 10B.

The second captured image acquiring unit 103B acquires a second captured image in which a user passing along a path along which a user is able to move to the parking lot is imaged. This path is a path along which a user is able to move between the parking lot and another place. For example, the path is a path along which a user is able to move between the parking lot and a facility (for example, a store).

The extraction unit 1062B extracts a user imaged in the second captured image out of users imaged in the first captured image with reference to the storage unit.

The display control unit 1064B displays availability information on a display unit when the extracted user approaches the parking lot, displays the availability information on the display unit when the extracted user approaches the parking lot through the path, and does not display the availability information any more when the extracted user moves away from the parking lot through the path. The display unit may be one of a display device externally connected to the information processing device 10B, a car navigation device mounted in a vehicle, and a smartphone carried by the user. The availability information is information on availability of a parking position.

According to this embodiment, since availability information is displayed when the extracted user approaches the parking lot and availability information is not displayed any more when the extracted user moves away from the parking lot, it is possible to display availability information when there is a likelihood that a parking position in the parking lot will be available.

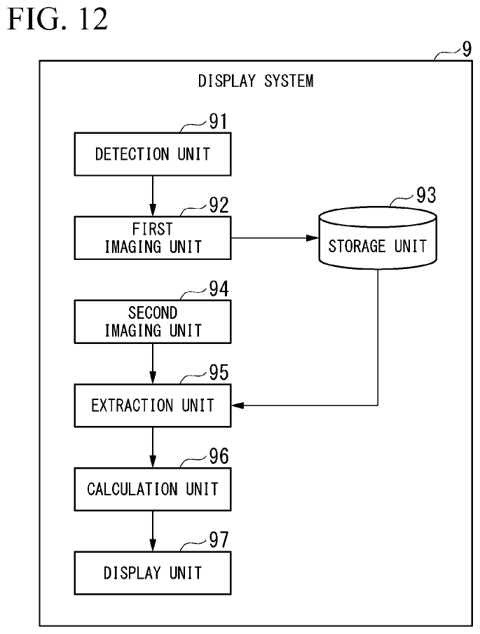

FIG. 12 is a diagram illustrating a configuration of a display system 9 according to the embodiment of the present invention.

The display system 9 according to the present invention includes a detection unit 91, a first imaging unit 92, a storage unit 93, a second imaging unit 94, an extraction unit 95, a calculation unit 96, and a display unit 97.

The detection unit 91 detects a parking position of a vehicle parked in a parking lot.

The first imaging unit 92 images a user alighting from the parked vehicle.

The storage unit 93 stores the detected position and the user.

The second imaging unit 94 images a user moving along a path along which a user is able to move to the parking lot.

The extraction unit 95 extracts a user imaged by the second imaging unit 94 out of users imaged by the first imaging unit 92 with reference to the storage unit 93.

The calculation unit 96 calculates a time over which the extracted user moves from the position at which the user has been imaged by the second imaging unit 94 to the position of the parking lot at which the vehicle from which the user has alighted parks.

The display unit 97 displays a relationship between the time based on the calculation result and the position in the parking lot.

Position detection may be performed by recording a program for realizing the functions of the information processing device, the server, or the display device illustrated in FIG. 1 on a computer-readable recording medium and causing a computer system to read and execute the program recorded on the recording medium. The “computer system” mentioned herein includes an OS or hardware such as peripherals.

The “computer system” includes a homepage provision environment (or display environment) when a WWW system is used.

The “computer-readable recording medium” means a portable medium such as a flexible disk, a magneto-optical disc, a ROM, or a CD-ROM or a storage device such as a hard disk incorporated into the computer system. The “computer-readable recording medium” includes a medium that holds a program for a predetermined time such as a volatile memory in a computer system serving as a server or a client. The program may be for realizing some of the aforementioned functions or may be for realizing the aforementioned functions in combination with a program stored in advance in the computer system. The program may be stored in a predetermined server, and the program may be delivered (downloaded or the like) via a communication line in response to a request from another device.

While an embodiment of the present invention has been described above with reference to the drawings, a specific configuration of the present invention is not limited to the embodiment and includes design or the like without departing from the gist of the present invention.

For example, the display device 30 may display an advertisement as well as display a parking situation of the parking lot.

The display device 30 may be a display device (a display) installed in a parking lot or a commercial facility or may transmit data indicating the parking situation to a display device such as a car navigation system, a smartphone, or a table terminal of a user and display the data on the display device of the user.

The second imaging unit 60 may be a camera that images the inside of an elevator. In this case, the extraction unit 1062 compares the first captured image acquired from the first imaging unit 50 with a second captured image for a user who has pushed a button with a floor including a parking lot (for example, the sixth floor when a parking lot is in the sixth floor) as a destination floor. When a destination is only the sixth floor and a plurality of users are in a cargo (a part of an elevator in which persons are), the extraction unit 1062 compares each user with the first captured image acquired from the first imaging unit 50. On the other hand, when a destination is not limited to the sixth floor, the extraction unit 1062 recognizes a user who has pushed a button for the sixth floor. The user who has pushed the button can be identified by detecting whether the user has touched the button for the sixth floor from the captured image.

In the aforementioned embodiment, the second imaging unit 60 and the third imaging unit 70 are different cameras, but the second imaging unit 60 and the third imaging unit 70 may be configured as a single camera or sensor as long as it can distinguish a user approaching the parking lot and a user moving away from the parking lot.

The display control unit 1064 may display a parking state of each parking position in color or symbol on the display unit 301. For example, the display control unit 1064 may display unavailability in “red,” display availability in “blue,” and display an exit schedule in turning on of a yellow lamp and an availability prediction timer.

In the aforementioned embodiment, the display control unit 1064 displays the availability prediction timer in a remaining time, but the present invention is not limited thereto, and the availability prediction timer may be displayed in a color corresponding to the remaining time out of a plurality of colors. Alternatively, the display control unit 1064 may display the availability prediction timer in a pictogram (a figure) corresponding to the remaining time.

The display control unit 1064 may set the priority order of available or exit-scheduled parking positions on the basis of a preset rule (for example, the priority of a parking position closer to a store entrance is higher) and preferentially perform guidance to parking positions with higher priority (for example, three highest parking positions).

Users recognized by the first imaging unit 50 and the second imaging unit 60 may be only drivers or may be all users alighting from a vehicle. When all users alighting from the vehicle are recognized, the display control unit 1064 may display an availability prediction timer when all the alighting users have been recognized by the second imaging unit 60.

When a plurality of vehicles wander in the parking lot, the display control unit 1064 may identify the wandering vehicles on the basis of vehicle numbers thereof from an image of a camera imaging the inside of the parking lot and may display different guidance details for the vehicles on the display devices 30 visible to a specific position when the wandering vehicles approach the specific position. For example, the display control unit 1064 generates a guidance table for determining an available or exit-scheduled parking position to which each parking waiting vehicle is guided on the basis of the parking state table and the positions of the wandering parking waiting vehicle.

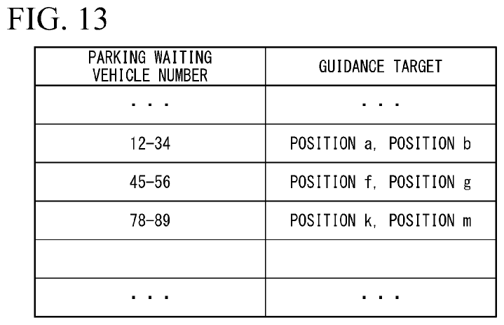

FIG. 13 is a diagram schematically illustrating an example of the guidance table.

As illustrated in the drawing, the guidance table includes entries such as a parking waiting vehicle number and a guidance target. The parking waiting vehicle number is a vehicle number of a parking waiting vehicle wandering in the parking lot. The guidance target is a parking position to which a vehicle with the corresponding parking waiting vehicle number is guided.

In the example illustrated in the drawing, a vehicle with a parking waiting vehicle number “12-34” is guided to a position a (an availability prediction timer) and a position b (available), and a vehicle with a parking waiting vehicle number “45-56” is guided to a position f (an availability prediction timer) and a position g (available), and a vehicle with a parking waiting vehicle number “78-89” is guided to a position k (an availability prediction timer) and a position m (available).

In this way, when the number of available parking positions in the parking lot is small and there are a plurality of exit-scheduled parking positions, the display control unit 1064 allocates parking positions which are guidance targets to wandering vehicles. Accordingly, the wandering vehicles can be segregated such that they do not struggle for the same position. That is, it is possible to avoid wandering vehicles struggling for parking at the same position out of positions with a likelihood of availability and available positions and to smooth parking.

Regarding what position is displayed for what vehicle, the display control unit 1064 stores a relationship between parking waiting vehicles and parking positions as guidance targets and displays availability or an availability prediction timer of a parking position for a vehicle approaching the display device 30 out of parking waiting vehicles wandering in the parking lot.

### REFERENCE SIGNS LIST

1, 9 Display system
10, 10A, 10B Information processing device
101, 101A, 101B Parking position acquiring unit
102, 102A, 102B First captured image acquiring unit
103, 103A, 103B Second captured image acquiring unit
104 Third captured image acquiring unit
105 Settlement information acquiring unit
106 Sensor value processing unit
1061, 1061A, 1061B Data processing unit
1062, 1062A, 1062B, 95 Extraction unit
1063, 1063A, 96 Calculation unit
1064, 1064A, 1064B Display control unit
1065 State storage unit
20 Server
201 Data processing unit
202, 93 Storage unit
30 Display device
301, 97 Display unit
40, 91 Detection unit
50, 92 First imaging unit
60, 94 Second imaging unit
70 Third imaging unit
80 Prior settlement machine

What is claimed is:

1. An information processing device comprising:
a parking position acquiring unit configured to acquire a parking position of a vehicle parked in a parking lot;
a first captured image acquiring unit configured to acquire a first captured image in which a user alighting from the parked vehicle is imaged;
a data processing unit configured to store the detected position and the user in a storage unit;
a second captured image acquiring unit configured to acquire a second captured image in which a user passing along a path along which the user is able to move to the parking lot is imaged;
an extraction unit configured to extract a user captured in the second captured image out of users captured in the first captured image with reference to the storage unit; and
a display control unit configured to cause a display unit to display availability information on the basis of the extraction result.

2. The information processing device according to claim 1, further comprising:
a calculation unit configured to calculate a time over which the extracted user moves from a position at which the user has been captured in the second captured image to the parking position at which the vehicle from which the user has alighted has been parked,
wherein the display control unit is configured to cause the display unit to display availability information on the display unit on the basis of a relationship between the time based on the calculation result and the parking position.

3. The information processing device according to claim 1, wherein the second captured image acquiring unit is configured to acquire the second captured image in which a path along which a user is able to move to only the parking lot is imaged.

4. The information processing device according to claim 1, wherein the display control unit is configured to cause the display unit to display availability information on the display unit along with a time based on the calculation result for each section included in the parking lot.

5. The information processing device according to claim 1, wherein the display control unit is configured to cause the display unit to display availability information on the display unit of a display device installed at a position corresponding to each section included in the parking lot.

6. The information processing device according to claim 1, further comprising:
a third captured image acquiring unit configured to acquire a third captured image in which a user moving in a direction in which the user moves away from the parking lot on the path along which a user is able to move to the parking is imaged,
wherein the second captured image acquiring unit is configured to acquire the second captured image in which a user moving to the parking lot is imaged, and
wherein the display control unit is configured to cause the display unit not to display the displayed time any more when a user included in the second captured image acquired by the second captured image acquiring unit is included in the third captured image acquired by the third captured image acquiring unit.

7. The information processing device according to claim 1, wherein the display control unit is configured to cause the display unit to display information indicating that a position of the parking lot at which a vehicle has been parked is available when a user has not been extracted from the second captured image acquired by the second captured image acquiring unit by the extraction unit and the vehicle has exited the parking lot.

8. The information processing device according to claim 1,
wherein the display control unit is configured to cause the display unit to display the availability information when the extracted user approaches the parking lot,
wherein the display control unit is configured to cause the display unit to display the availability information on the display unit when the extracted user approaches the parking lot through the path, and
wherein the display control unit is configured to cause the display unit not to display the availability information any more when the extracted user moves away from the parking lot through the path.

9. The information processing device according to claim 1, further comprising:
a settlement information acquiring unit configured to acquire settlement information indicating that prior settlement of a parking fee has been performed using a prior settlement machine,
wherein the calculation unit is configured to calculate a time over which a user moves from the prior settlement machine to the position of the parking lot at which the vehicle for which there has been prior settlement has been parked when the settlement information is acquired.

10. The information processing device according to claim 1, wherein the display control unit is configured to cause the display unit to display a relationship between the time based on the calculation result and the position of the parking lot on the display unit when an availability ratio in the parking lot is less than a predetermined value.

11. The information processing device according to claim 1, wherein the display device is provided at an entrance gate of the parking lot.

12. A display system comprising:
a detection unit configured to detect a parking position of a vehicle parked in a parking lot;
a first imaging unit configured to image a user alighting from the parked vehicle;
a storage unit configured to store the detected position and the user;
a second imaging unit configured to image a user passing along a path along which the user is able to move to the parking lot;
an extraction unit configured to extract a user imaged by the second imaging unit out of users imaged by the first imaging unit with reference to the storage unit;
a calculation unit configured to calculate a time over which the extracted user moves from a position at which the user has been imaged by the second imaging unit to the parking position at which the vehicle from which the user has alighted has been parked; and
a display unit configured to display a relationship between the time based on the calculation result and the position of the parking lot.

13. A display method comprising:
acquiring a parking position of a vehicle parked in a parking lot;
acquiring a first captured image in which a user alighting from the parked vehicle is imaged;
storing the detected position and the user in a storage unit;
acquiring a second captured image in which a user passing along a path along which the user is able to move to the parking lot is imaged;
extracting a user captured in the second captured image out of users captured in the first captured image with reference to the storage unit;
calculating a time over which the extracted user moves from a position at which the user has been imaged in the second captured image to the parking position at which the vehicle from which the user has alighted has been parked; and
displaying a relationship between the time based on the calculation result and the position of the parking lot.
